(19) United States
(12) Patent Application Publication
(10) Pub. No.: US 2015/0077820 A1
(43) Pub. Date: Mar. 19, 2015

(54) IMAGE PROJECTION APPARATUS

(71) Applicant: ALPS ELECTRIC CO., LTD., Tokyo (JP)

(72) Inventor: YOSHIHIRO SOMENO, Miyagi-ken (JP)

(73) Assignee: Alps Electric Co., Ltd.

(21) Appl. No.: 14/485,268

(22) Filed: Sep. 12, 2014

(30) Foreign Application Priority Data
Sep. 17, 2013 (JP) 2013-191640

(51) Int. Cl. G03H 1/00; G03H 1/10; G03H 1/02

(52) U.S. Cl. CPC G03H 1/0005; G03H 1/02; G03H 1/10; G03H 2001/0212; G03H 2001/0216
USPC 359/11

(57) ABSTRACT

An aperture forming member is provided on a light path from a laser light source to a collimator lens, and a plurality of apertures are formed by a plurality of wall bodies of the aperture forming member. The distances between the apertures and the outer surface of an effective beam decrease in the order of L1, L2, and L3. By providing the plurality of apertures, entrance of stray light into a phase conversion array can be prevented.

### CLAIM OF PRIORITY

This application claims benefit of priority to Japanese Patent Application No. 2013-191640 filed on Sep. 17, 2013, which is hereby incorporated by reference in its entirety.

### BACKGROUND

1. Field of the Disclosure

The present disclosure relates to an image projection apparatus in which laser light from a laser light source is collimated by a collimator lens, and then converted into a hologram image by a phase conversion array, and is then projected.

2. Description of the Related Art

An image display apparatus used as a so-called head-up display apparatus is disclosed in Japanese Unexamined Patent Application Publication No. 2011-90076.

This image display apparatus has three laser light sources that emit laser beams of wavelengths of R, G, and B. The laser beam emitted from each laser light source is given to a two-dimensional modulation element, and an image is generated. The light beam containing the image is reflected by a mirror, and is given to a hologram optical element disposed in a windshield of a vehicle. The hologram optical element is a hologram mirror, and light reflected by this hologram mirror is given to a driver. As a result, the driver can view a virtual image in front of the windshield.

The image display apparatus described in Japanese Unexamined Patent Application Publication No. 2011-90076 employs a small liquid crystal panel or a digital mirror device as a two-dimensional conversion element. These generate a two-dimensional image by turning on or off the transmission of laser light for each pixel. Therefore, the use efficiency of laser light is low, and there is a limit in improving the contrast of an image projected on a virtual image in front of the windshield.

To solve this problem, the present invention proposes to use a phase conversion array as an element for generating an image. This phase conversion array converts the phases of laser beams passing through many conversion points, makes beams passing through adjacent conversion points interfere with each other, and concentrates light in dots to many pixels for expressing an image. In this method, the lens effect of the phase conversion array can be exerted, and light shielding for each dot as in the conventional light switch array is not performed, and a light absorption component is small. Therefore, the use efficiency of laser light is high, and a projection image that is high-intensity, is easily corrected, and has an added function such as a three-dimensional image can be generated.

However, the laser beam needs to be incident on the phase conversion array as a collimated beam at a predetermined incident angle. If stray light at an unexpected incident angle is incident, for example, projection light is generated in a part other than pixels to be generated, the quality of the display image may thereby be decreased, and in particular, the contrast may be adversely affected.

On the other hand, as described in Japanese Unexamined Patent Application Publication No. 2008-216697, in an image forming apparatus, an aperture is disposed between a laser light source and a collimator lens or in front of the collimator lens, and the diameter of a beam is limited by this aperture. However, if this aperture is simply disposed between the laser light source and the phase conversion array element, a new problem arises that light diffracted by the aperture is incident on the phase conversion array as new stray light.

### SUMMARY

An image projection apparatus includes a laser light source, a collimator lens configured to convert laser light emitted from the laser light source into a collimated beam, a phase conversion array configured to phase-convert the collimated beam passing through the collimator lens to generate a hologram image, and a projection portion configured to project the hologram image generated by the phase conversion array. A plurality of apertures are arranged between the laser light source and the collimator lens in a direction along the optical axis at intervals.

Since the image projection apparatus of the present invention is provided with the plurality of apertures between the light source unit and the collimator lens, stray light generated by diffraction of light or reflection of light due to an aperture can be shielded by the next aperture, and the probability that stray light reaches the phase conversion array can be reduced.

### BRIEF DESCRIPTION OF THE DRAWINGS

FIG. 1 is an explanatory diagram showing a vehicular head-up display apparatus as an embodiment of an image projection apparatus of the present invention;

FIG. 2 shows the configuration of an exemplary embodiment of the image projection apparatus;

FIG. 3 is a sectional view showing the structure on a light path from a laser light source to a collimator lens;

FIG. 4 is a sectional view showing the structure on a light path from the collimator lens to a phase conversion array;

FIG. 5 is a front view in the direction of arrow V-V of FIG. 3; and

FIG. 6 is a sectional view showing a mode in which a shielding member is provided on the light path from the collimator lens to the phase conversion array.

### DESCRIPTION OF THE EXEMPLARY EMBODIMENTS

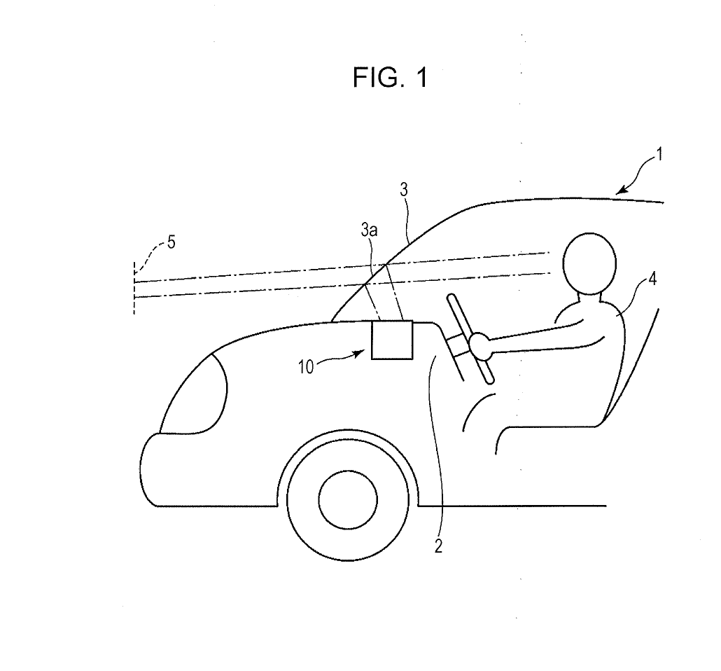

An image projection apparatus 10 of an embodiment of the present invention shown in FIG. 1 is mounted on an automobile and is used as a so-called head-up display apparatus.

The image projection apparatus 10 is disposed in a dashboard 2 in the front of a cabin of the automobile 1. A hologram image is projected from the image projection apparatus 10 onto a projection region 3a of a windshield 3. This image is reflected in the projection region 3a toward a driver 4. A virtual image 5 is formed in front of the windshield 3, and the driver 4 can thereby be made to feel as if they are viewing an image in front of the windshield 3.

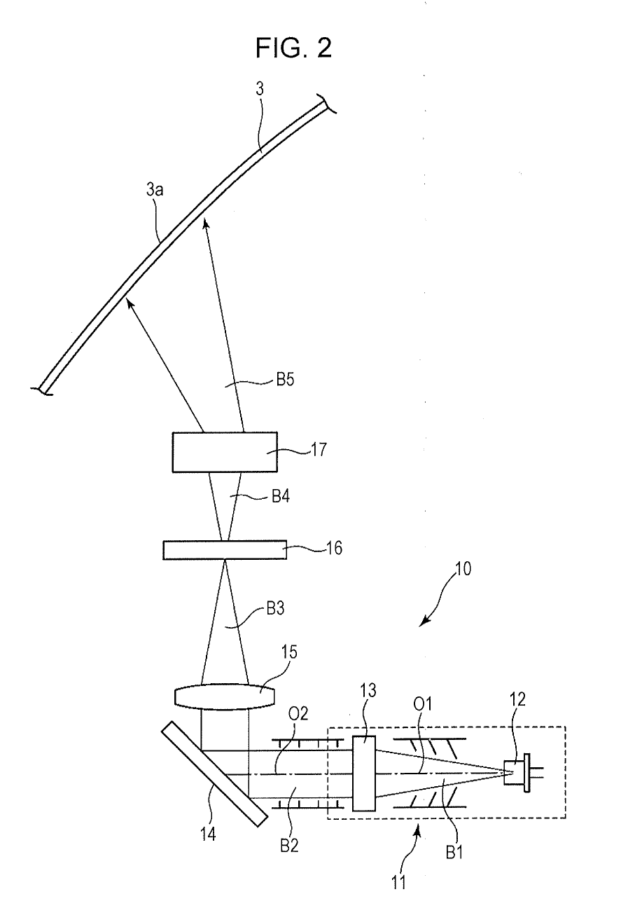

FIG. 2 schematically shows the configuration of the image projection apparatus 10.

The image projection apparatus 10 has a light source unit 11. The light source unit 11 includes a laser light source 12, and a collimator lens 13 located in front of the light emitting path of the laser light source 12. A phase conversion array 14 is provided in front of the light path of the light source unit 11. The phase conversion array 14 faces the optical axis O2 of the collimator lens 13 at an angle of 45 degrees. A Fourier transform lens 15 and a diffuser 16 are disposed in front of the light path of the phase conversion array 14, and a projection optical system 17 is disposed in front thereof. The Fourier transform lens 15, the diffuser 16, and the projection optical system 17 constitute a projection portion.

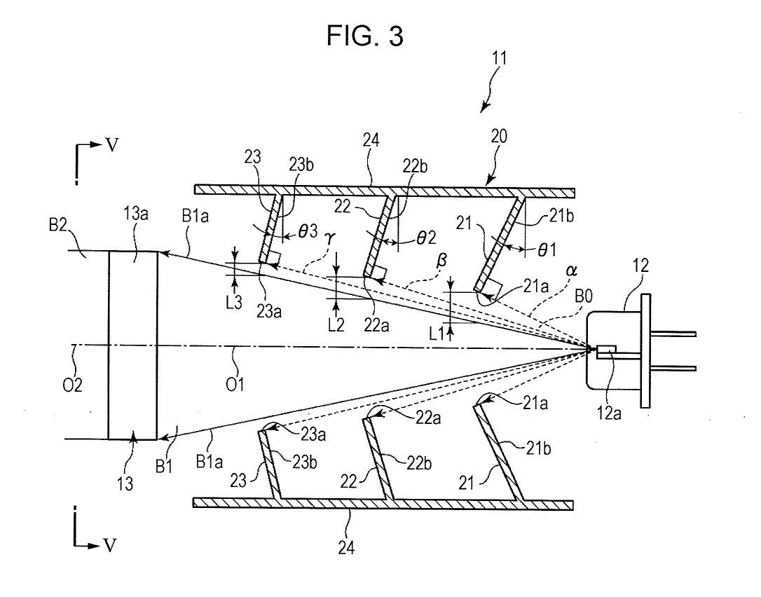

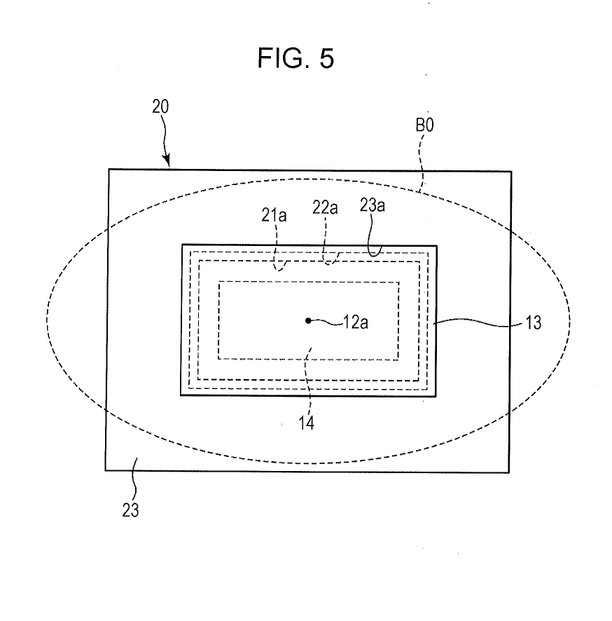

As shown in FIG. 3, a semiconductor laser chip 12a is disposed in a case of the laser light source 12, and a laser beam is emitted forward. As schematically shown in FIG. 5 (a view in the direction of arrow V-V of FIG. 3), the laser beam B0 emitted from the semiconductor laser chip 12a is a divergent beam that has an elliptical or oval cross-section and that gradually increases in diameter toward the front.

Of the laser beam B0, an effective beam B1 incident in the effective diameter of the collimator lens 13 is shown in FIG. 3. The effective beam B1 is converted by the collimator lens 13 into a collimated beam B2 having an infinite focal length. As shown in FIG. 5, the shape of the effective diameter of the collimator lens 13 is a rectangular shape whose long side extends in the left-right direction (a direction perpendicular to the paper plane of FIG. 3). For this reason, the collimated beam B2 converted by the collimator lens 13 has a rectangular cross-section.

The phase conversion array 14 is of a reflective type, and a liquid crystal material is enclosed between two substrates. Intersections of electrodes provided on the two substrates are conversion points, and the conversion points are regularly arranged. Owing to an electric field applied to the conversion points, crystals of the liquid crystal layer tilt in the thickness direction of the liquid crystal layer, and the phases of laser beams passing through the conversion points are thereby converted. By the interference of laser beams of different phases passing through adjacent conversion points, laser light is collected in dots to pixels of an image desired to be displayed, and a predetermined hologram image is generated.

Unlike the conventional liquid crystal panel or digital mirror device, the phase conversion array 14 does not turn on or off light passing through it for each pixel but concentrates light energy in space to pixels, and is therefore light energy efficient, and a hologram image with high contrast can be generated.

As shown in FIG. 2, a converted beam B3 reflected by the phase conversion array 14 and passing through the Fourier transform lens 15 is imaged on the diffuser 16 in a defocus state. A diffusion light B4 passing through the diffuser 16 is image-adjusted by the projection optical system 17, becomes an adjusted beam B5, and is projected onto the projection region 3a of the windshield 3.

In the above-described embodiment, only one light source unit 11 is provided, and a laser beam of a single wavelength is incident on the phase conversion array 14. However, for example, two types of light source units 11 that emit laser beams of different wavelengths of R (628 nm) and G (515 nm) may be arranged vertically in FIG. 2. In this case, laser beams emitted from respective laser light sources are converted into collimated beams having a rectangular cross-section by collimator lenses 13 provided for respective laser light source. The collimated beams of laser light of two wavelengths are incident on different regions of the phase conversion array 14, and light beams of two wavelengths of R (red) and G (green) are each concentrated in dots to pixels constituting an image. A hologram image including an image in which two colors of R and G are mixed is generated.

Three light source units that emit laser beams of three wavelengths of R, G, and B may be used.

As shown in FIG. 3, in the light source unit 11, an aperture forming member 20 is disposed between the laser light source 12 and the collimator lens 13. The aperture forming member 20 is formed of a metal material such as stainless steel or a synthetic resin material.

A plurality of wall bodies are provided in the aperture forming member 20. In this embodiment, three wall bodies: a first wall body 21, a second wall body 22, and a third wall body 23 are arranged from the laser light source 12 toward the collimator lens 13. However, the number of the wall bodies is not particularly limited as long as it is two or more.

The inner edge of the first wall body 21 defines a first aperture 21a, the inner edge of the second wall body 22 defines a second aperture 22a, and the inner edge of the third wall body 23 defines a third aperture 23a. As shown in FIG. 5, the first, second, and third apertures 21a, 22a, and 23a have rectangular shapes similar to the rectangular shape of the effective diameter of the collimator lens 13.

In FIG. 3, the outer surface of the effective beam B1 within the range from the laser light source 12 to the effective diameter of the collimator lens 13 is denoted by reference sign B1a. The distance between the first aperture 21a and the outer surface B1a is denoted by L1, the distance between the second aperture 22a and the outer surface B1a is denoted by L2, and the distance between the third aperture 23a and the outer surface B1a is denoted by L3. The distances L1, L2, and L3 are measured in a direction perpendicular to the optical axis O1 of the effective beam B1. The distances L1, L2, and L3 gradually decrease in the order of distance L1, distance L2, and distance L3, (L1>L2>L3).

In FIG. 3, there are shown a first virtual surface a extending from the light emitting point of the laser light source 12 to the first aperture (inner edge) 21a, a second virtual surface β extending from the light emitting point of the laser light source 12 to the second aperture (inner edge) 22a, and a third virtual surface γ extending from the light emitting point of the laser light source 12 to the third aperture (inner edge) 23a. The virtual surfaces α, β, and γ each mean a divergent advancing path of a light component of the laser beam B0 emitted from the laser light source 12.

The angle between a first facing surface 21b of the first wall body 21 that faces the laser light source 12 and the virtual surface α is 90 degrees ±20 degrees or less. Similarly, the angle between a second facing surface 22b of the second wall body 22 that faces the laser light source 12 and the virtual surface β, and the angle between a third facing surface 23b of the third wall body 23 that faces the laser light source 12 and the virtual surface γ are also 90 degrees ±20 degrees or less. It is more preferable that these angles be 90 degrees ±10 degrees or less. It is most preferable that these angles be 90 degrees as shown in FIG. 3.

The angles θ1, θ2, and θ3 between the facing surfaces 21b, 22b, and 23b of the wall bodies 21, 22, and 23 and a plane perpendicular to the optical axis O1 decrease in the order of θ1, θ2, and θ3 (θ1>θ2>θ3).

The facing surfaces 21b, 22b, and 23b of the wall bodies 21, 22, and 23 have a light reflection prevention structure or a light absorption structure. For example, the facing surfaces 21b, 22b, and 23b have a light scattering surface having fine recesses and protrusions. Alternatively, a light reflection prevention film formed by laminating thin films or a light absorption film that contains carbon and absorbs light and converts into heat energy is formed on the facing surfaces 21b, 22b, and 23b.

In the light source unit 11 shown in FIG. 3, the laser beam B0 emitted from the laser light source 12 is gradually narrowed by the plurality of apertures 21a, 22a, and 23a, and is given to the collimator lens 13. Therefore, a light component on the outer side of the effective beam B1 can be prevented from entering the collimator lens 13 as stray light.

In particular, the distances between the outer surface B1a of the effective beam B1 and the plurality of apertures 21a, 22a, and 23a gradually decrease in the order of L1, L2, and L3 (L1>L2>L3). Therefore, stray light diffracted by the first aperture 21a can be easily shielded by the second aperture 22a, and stray light diffracted by the second aperture 22a can be easily shielded by the third aperture 23a.

A light component divergently advancing along the virtual surface α on the outer side of the effective beam B1 is incident on a part of the first facing surface 21b close to the first aperture 21a at an angle close to 90 degrees. Therefore, light is easily absorbed by the reflection prevention film or light absorption film, and irregular reflection in directions other than the direction of return light to the laser light source 12 hardly occurs. The same holds true for the relationship between a light component divergently advancing along the virtual surface β and the second aperture 22a, and the relationship between a light component divergently advancing along the virtual surface γ and the third aperture 23a.

Since the light source unit 11 has the above-described aperture forming member 20, stray light incident on the collimator lens 13 at an angle different from the diverging angle of the effective beam B1 can be limited, and a stray light component not parallel to the optical axis O2 can be prevented from being superimposed on the collimated beam B2 converted by the collimator lens 13.

The side surfaces (four side surfaces) of the collimator lens 13 also have a light reflection prevention structure or a light absorption structure. By providing the side surfaces 13a with this structure, a phenomenon in which light passing through the collimator lens 13 is internally reflected by the side surfaces 13a can be reduced, and stray light due to this reflected light can be prevented from entering the collimated beam B2.

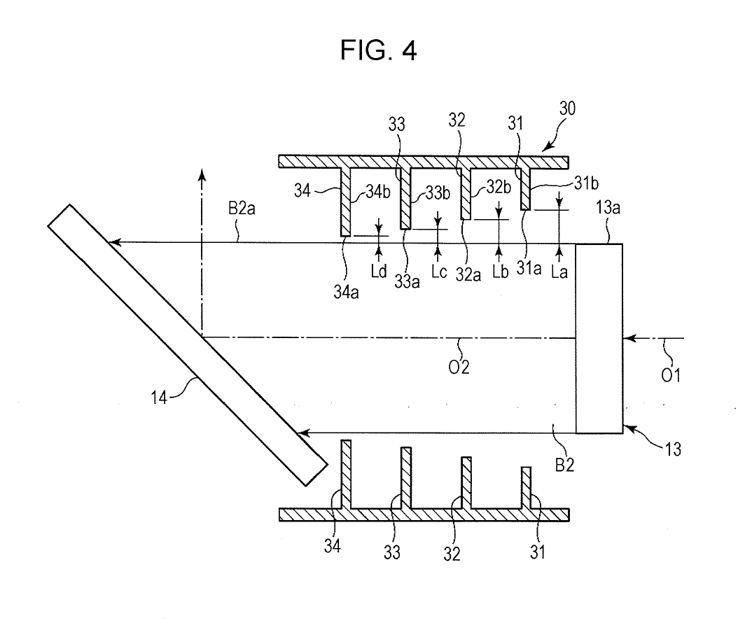

As shown in FIG. 4, a second aperture forming member 30 is provided between the collimator lens 13 and the phase conversion array 14.

The second aperture forming member 30 has a plurality of wall bodies 31, 32, 33, and 34, and the inner edges of the wall bodies 31, 32, 33, and 34 define apertures 31a, 32a, 33a, and 34a, respectively. The shapes of the apertures 31a, 32a, 33a, and 34a are rectangular shapes similar to the cross-sectional shape of the collimated beam B2. The distances La, Lb, Lc, and Ld between the apertures 31a, 32a, 33a, and 34a and the outer surface B2a of the collimated beam B2 in the direction of a plane perpendicular to the optical axis O2 decrease in the order of La, Lb, Lc, and Ld (La>Lb>Lc>Ld).

Facing surfaces 31b, 32b, 33b, and 34b of the wall bodies 31, 32, 33, and 34 that face the collimator lens 13 have a light reflection prevention structure or a light absorption structure.

Since the plurality of apertures 31a, 32a, 33a, and 34a are provided between the collimator lens 13 and the phase conversion array 14, and the distances between the apertures and the outer surface B2a of the collimated beam B2 are in the relationship of La>Lb>Lc>Ld, stray light generated in the light path between the collimator lens 13 and the phase conversion array 14 can be prevented from being incident on the phase conversion array 14.

The phase conversion array 14 controls the tilt of the liquid crystal material in the optical axis direction at a plurality of conversion points, and can thereby change the phases of beams passing through the conversion points. Light components of different phases passing through adjacent conversion points interfere with each other, laser light is collected in dots to pixels of an image desired to be displayed, and a predetermined hologram image is generated. Therefore, if stray light whose incident angle is significantly different from a predetermined incident angle enters light incident on each conversion point, for example, a ghost image appears in the hologram image, and the display quality is decreased.

In the embodiment shown in FIG. 3 and FIG. 4, by providing the aperture forming members 20 and 30, the above-described stray light can be prevented from advancing, and the display quality of a hologram image can be improved.

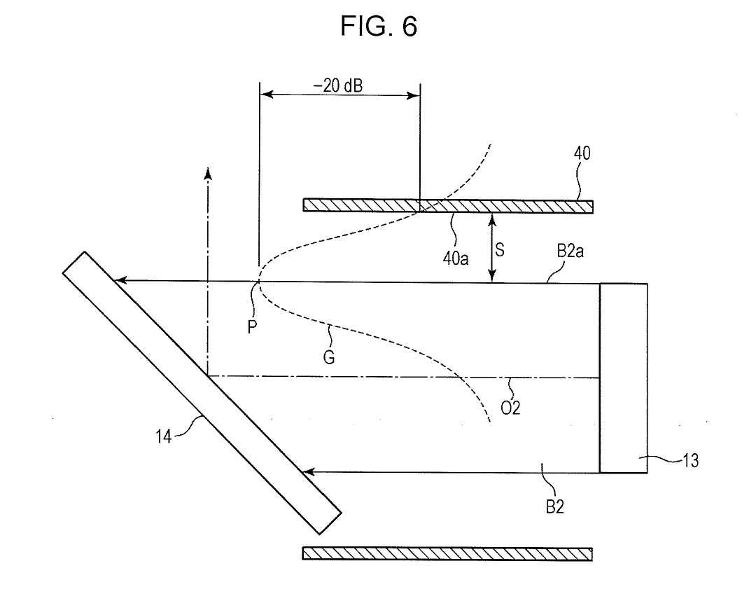

As shown in FIG. 6, when the second aperture forming member 30 shown in FIG. 4 is not used, stray light can be prevented from being incident on the phase conversion array 14 by securing a relatively large space on the outer side of the collimator lens 13 and the outer surface B2a of the collimated beam B2 reaching the phase conversion array 14.

In FIG. 6, a square tubular shielding member 40 is provided on the outer side of the collimated beam B2. In this case, by setting the distance S between the outer surface B2a of the collimated beam B2 and the inner surface 40a of the shielding member 40 in the direction of a plane perpendicular to the optical axis O2 as follows, stray light is easily prevented from entering the collimated beam B2.

As shown in FIG. 6, a Gaussian intensity distribution G having a peak value P of light intensity on the outer surface B2a of the collimated beam B2 is assumed such that the center is located on the outer surface B2a. In this case, the distance S is set such that the inner surface 40a is located at a position where light intensity is −20 dB or less of the peak value P in the Gaussian intensity distribution.

Since the inner surface 40a is located at a position where the light intensity is −20 dB or less of the light intensity on the outer surface B2a of the collimated beam B2, the intensity of light reflected by the inner surface 40a can be reduced, and stray light having high intensity can be prevented from entering the phase conversion array 14. This can be easily adapted for use in projecting a plurality of different light sources onto the phase conversion array.

What is claimed is:

1. An image projection apparatus comprising:
a laser light source;
a collimator lens configured to convert laser light emitted from the laser light source into a collimated beam;
a phase conversion array configured to phase-convert the collimated beam passing through the collimator lens to generate a hologram image; and
a projection portion configured to project the hologram image generated by the phase conversion array,
wherein a plurality of apertures are arranged at intervals between the laser light source and the collimator lens in a direction along the optical axis.

2. The image projection apparatus according to claim 1, wherein a gap in a direction perpendicular to the optical axis is provided between the outer surface of an effective beam reaching the collimator lens from the laser light source and each of the apertures, and the gap becomes smaller toward the collimator lens.

3. The image projection apparatus according to claim 1, wherein a plurality of wall surfaces facing the laser light source are provided between the laser light source and the collimator lens, inner edges of the wall surfaces define the apertures, and angles between virtual surfaces extending from the laser light source to the inner edges and the wall surfaces are 90 degrees ±20 degrees or less.

4. The image projection apparatus according to claim 3, wherein the wall surfaces have a light reflection prevention structure or a light absorption structure.

5. The image projection apparatus according to claim 1, wherein a plurality of second apertures are arranged between the collimator lens and the phase conversion array in a direction along the optical axis at intervals.

6. The image projection apparatus according to claim 5, wherein a gap in a direction perpendicular to the optical axis is provided between the outer surface of the collimated beam extending from the effective diameter of the collimator lens and each of the second apertures, and the gap becomes smaller toward the phase conversion array.

7. The image projection apparatus according to claim 1, wherein a space is formed between the collimator lens and the phase conversion array and on the outer side of the collimated beam; and the extending distance of the space from the outer surface of the collimated beam is set such that when a Gaussian intensity distribution having a peak value of light intensity on the outer surface of the collimated is assumed, light intensity is −20 dB or less of the peak value.

8. The image projection apparatus according to claim 1, wherein the side surfaces of the collimator lens have a light reflection prevention structure or a light absorption structure.
